(19) United States
(12) Patent Application Publication
(10) Pub. No.: US 2008/0189137 A1
(43) Pub. Date: Aug. 7, 2008

(54) Systems and Methods For Retrieving Relevant Prior Medical Examination Reports Based on Report Content

(75) Inventors: Tom Gentles, Algonquin, IL (US); Eric Feingold, Philadelphia, PA (US); Lawrence Chow, Portland, OR (US); Sandip Biswal, Stanford, CA (US); Raghav Raman, Cupertino, CA (US); Vijaykalyan Yeluri, Sunnyvale, CA (US); Denny Lau, Redwood City, CA (US)

Correspondence Address: MCANDREWS HELD & MALLOY, LTD, 500 WEST MADISON STREET, SUITE 3400, CHICAGO, IL, 60661, US

(73) Assignees: General Electric Company, Schenectady, NY (US); The Board of Trustees of The Leland Stanford Junior University, Palo Alto, CA (US)

(21) Appl. No.: 11/670,242

(22) Filed: Feb. 1, 2007

(51) Int. Cl. G06Q 50/00

(52) U.S. Cl. 705/3

(57) ABSTRACT

Certain embodiments of the present invention provide a system for the identification and retrieval of relevant archived medical information. The system includes a user interface component and a processing component. The user interface component is adapted to determine a key, which includes one or more key values. The key values may represent one or more anatomical feature of a patient. The processing component is adapted to aggregate data based at least in part on the key values. The system may also include a searchable database containing relevant archived medical information. The system may also include a display device and a storage device adapted to, respectively, display and store data retrieved from the database.

### BACKGROUND OF THE INVENTION

The present invention generally relates to search and analysis of medical information. More specifically, the present invention relates to systems and methods for identification and retrieval of relevant prior electronic medical record data based on record content.

Healthcare environments, such as hospitals or clinics, include clinical information systems, such as hospital information systems (HIS), radiology information systems (RIS), clinical information systems (CIS), and cardiovascular information systems (CVIS), and storage systems, such as picture archiving and communication systems (PACS), library information systems (LIS), and electronic medical records (EMR). Information stored may include patient medical histories, imaging data, test results, diagnosis information, management information, and/or scheduling information, for example. The information may be centrally stored or divided among a plurality of locations. Healthcare practitioners may desire to access patient information or other information at various points in a healthcare workflow. For example, during surgery, medical personnel may access patient information, such as images of a patient's anatomy, that are stored in a medical information system. Alternatively, medical personnel may enter new information, such as history, diagnostic, or treatment information, into a medical information system during an ongoing medical procedure.

Hospitals typically utilize computer systems to manage the various departments within a hospital and data about each patient is collected by a variety of computer systems. For example, a patient may be admitted to the hospital for a Transthoracic Echo (TTE). Information about the patient (e.g., demographics and insurance) could be obtained by the HIS and stored on a patient record. This information could then be passed to the CVIS, for example. Typically the CVIS is a product of one company, while the HIS is the product of another company. As a result, the database between the two may be different. Further, information systems may capture/retain and send different levels of granularity in the data. Once the patient information has been received by the CVIS, the patient may be scheduled for a TTE in the echo lab. Next, the TTE is performed by the sonographer. Images and measurements are taken and sent to the CVIS server. The reading physician (e.g., an echocardiographer) sits down at a review station and pulls the patient's TTE study. The echocardiographer then begins to review the images and measurements and creates a complete medical report on the study. When the echocardiographer completes the medical report, the report is sent to the CVIS server where it is stored and associated with the patient through patient identification data. This completed medical report is an example of the kind of report that could be useful to other health care practitioners who subsequently treat or examine the patient.

When radiologists and referring physicians are making a diagnosis for a patient, they often need to find relevant historical information for the patient to better understand the patient's clinical history. The historical information for radiology could be found in the patient's historical radiology reports. If the patient has had a large number of exams for many unrelated illnesses, then finding the relevant report information may be time consuming.

There are search engines that allow users to perform free text search on reports. However, there is no automatic preparation and display of relevant reports.

There is also ongoing research to turn free text reports to structured reports using natural language processing engines.

As medical technology becomes more sophisticated, clinical analysis may also become more sophisticated. Increasing amounts of data are generated and archived electronically. With the advent of clinical information systems, a patient's history may be available at a touch of a button. While accessibility of information is advantageous, time is a scarce commodity in a clinical setting. To realize a full benefit of medical technological growth, it would be highly desirable for clinical information to be organized and standardized. A clinical or healthcare environment is a crowded, demanding environment that would benefit from organization and improved ease of use of electronic medical records, data storage systems, and other equipment used in the healthcare environment. A healthcare environment, such as a hospital or clinic, encompasses a large array of professionals, patients, and equipment. Personnel in a healthcare facility must manage a plurality of patients, systems, and tasks to provide quality service to patients. Healthcare personnel may encounter many difficulties or obstacles in their workflow.

A variety of distractions in a clinical environment may frequently interrupt medical personnel or interfere with their job performance. Data entry and access is complicated in a typical healthcare facility. Lack of easy access to relevant medical data may result in inefficient workflow and service to clients, which may impact a patient's health and safety or result in liability for a healthcare facility.

Thus, there is a need for systems and methods to efficiently identify and retrieve relevant stored medical information.

### BRIEF SUMMARY OF THE INVENTION

Certain embodiments of the present invention provide a system for the identification and retrieval of relevant archived medical information. The system includes a user interface component and a processing component. The user interface component is adapted to determine a key, which includes one or more key values. The key values may represent one or more anatomical feature of a patient. The processing component is adapted to aggregate data based at least in part on the key values. The system may also include a searchable database containing relevant archived medical information. The system may also include a display device and a storage device adapted to, respectively, display and store data retrieved from the database.

Certain embodiments of the present invention provide a method for the identification and retrieval of relevant archived medical information. The method includes determining a key that includes one or more key values and aggregating data based at least in part on the key values. The method may include aggregating data from medical records. The method may also include retrieving the identified medical records that contain the key values.

Certain embodiments of the present invention provide a computer-readable storage medium. The computer-readable storage medium includes a set of instructions for execution on a computer. The set of instructions includes an initialization routine adapted to determine a key and key values, a selection routine adapted to aggregating data based at least in part on the key values, and a display routine adapted to displaying data that contains the key values.

### BRIEF DESCRIPTION OF SEVERAL VIEWS OF THE DRAWINGS

FIG. 1 illustrates an exemplary system for the identification and retrieval of relevant archived medical information.

FIG. 2 illustrates an exemplary method for identifying and retrieving relevant archived medical information.

FIG. 3 illustrates an exemplary table of archived medical information for an individual patient.

FIG. 4 illustrates a fall chemistry metabolic panel for an individual patient.

FIG. 5 illustrates a full radiology report for an individual patient.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF THE INVENTION

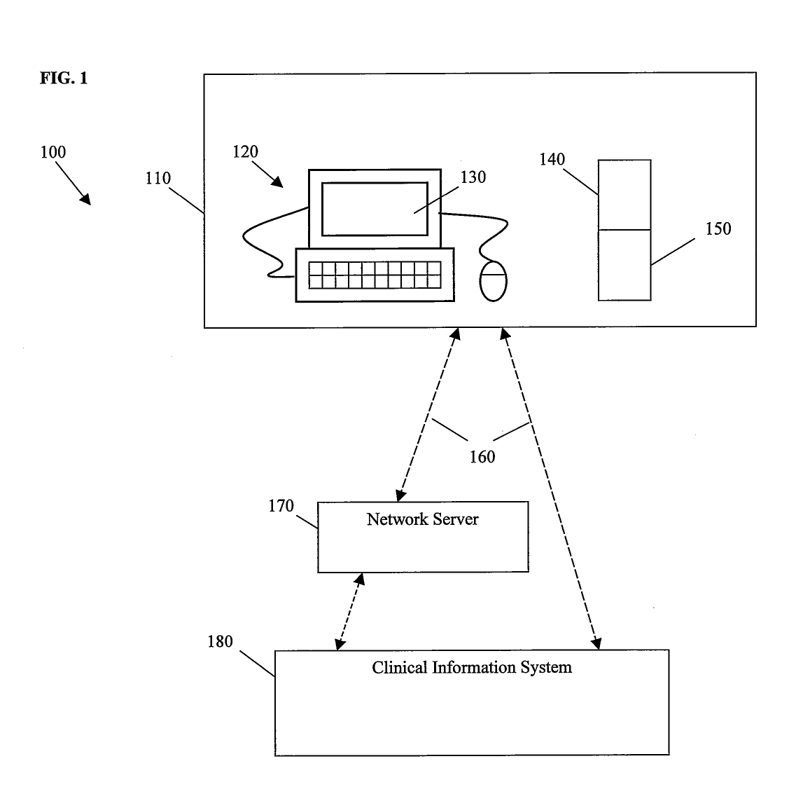

FIG. 1 illustrates a system 100 for the identification and retrieval of relevant archived medical information contained in prior medical examination reports according to an embodiment of the present invention. The identification and retrieval system 100 includes a workstation 110, a user interface 120, a display device 130, a processor 140, a storage device 150, a communication component 160, a network server 170, and a clinical information system 180.

The workstation 110 and the network server 170 may communicate with each other by way of a communication component 160. The network server 170 and a clinical information system 180 may communicate with each other by way of a communication component 160.

In another embodiment of the present invention workstation 110 and clinical information system 180 may communicate with each other directly by way of a communication component 160.

The user interface 120 is adapted to determine a key. The key may include one or more key values. The key and/or the one or more key values may be based at least in part on one or more anatomical features of a patient. For example, the one or more key values may include an organ, an organ system, a type of tissue, or other anatomical features.

The user interface 120 may be connected to an input device, such as a keyboard, mousing device, and/or other input device, for example.

The display device 130 is adapted to display the data. For example, the data may be displayed in a table, as shown in further detail below. The display device 130 may include, for example, a computer monitor or a display screen on a handheld device. The display device 130 may be a part of the user interface 110.

The processor 140 is adapted to aggregate data. The data may be aggregated based at least in part on the one or more key values. For example, relevant archived medical information can be more quickly identified if the reports are compiled based on the presence of relevant key values.

The system 100 may automatically select key values based on the exam or test being conducted or interpreted. For example, each imaging exam follows a preset protocol for image acquisition. Thus, each type of imaging exam could be mapped to organs, tissues or other anatomical structures likely to be imaged as part of the preset protocol before the imaging exam was actually conducted for an individual patient. For example, if a radiologist is preparing to perform a computed tomography chest-abdomen exam, then the key values may automatically include the following organs that are imaged as part of that preset protocol:

1. liver

2. gallbladder

3. spleen

4. adrenals

5. kidneys

6. pancreas

7. small intestine

8. large intestine

Alternatively, a physician may direct the aggregation of data by the processor 140 by selecting the key value manually through the user interface 120.

In an embodiment, the system 100 identifies synonyms that are closely related to the key value. For example, processor 140 may aggregate data based not only on the term “heart” but also on the related terms “cardiac” and “myocardial”. This would require using a standardized vocabulary, such as Unified Medical Language System (UMLS), to identify all the synonyms.

In another embodiment of the invention, other relevant historical clinical information such as pathology tests, lab tests, microbiology tests, radiology reports, and surgical notes could be associated with certain organs, tissues, or other anatomical structures. Thus, other relevant historical clinical information that is related to a particular anatomical structure may be aggregated by processor 140 by selection of a key value that represents that anatomical structure.

The storage device 150 is adapted to store the data. For example, the data may be stored in internal or external memory.

The communication component 160 may include a modem, wireless modem, cable modem, Bluetooth™ wireless device, infrared communication device, wired communication device, and/or other communication device, for example.

The communication component 160 communicates and transfer data via one or more communication protocols, such as the DICOM protocol.

The communication component 160 coordinates with processor 140 in the workstation 110 to establish a connection between the workstations 110 and remotely execute functionality and/or transfer data, for example.

Server 170 can include any computer-readable storage and retrieval device that is accessible over an intranet or over the Internet. Server 170 can include a computer-readable storage medium suitable for storing the data for later retrieval and viewing on a display device 130.

Clinical information system 180 may include, for example, hospital information systems (HIS), radiology information systems (RIS), clinical information systems (CIS), and cardiovascular information systems (CVIS), and storage systems, such as picture archiving and communication systems (PACS), library information systems (LIS), and electronic medical records (EMR).

In an embodiment, workstation 110 may communicate with and retrieve data from an EMR storage system.

In operation, workstation 110 communicates with clinical information system 180, either directly or indirectly through network server 170. User interface 120 determines a key and appropriate key values to identify relevant medical information. Medical information is retrieved from the clinical information system 180. Processor 140 aggregates retrieved medical information based in part on one or more key values. Aggregated medical information is displayed on display device 130 and may be stored in storage device 150.

As discussed above, the components, elements, and/or functionality of the system 100 may be implemented alone or in combination in various forms in hardware, firmware, and/or as a set of instructions in software, for example. Certain embodiments may be provided as a set of instructions residing on a computer-readable medium, such as a memory, hard disk, DVD, or CD, for execution on a general purpose computer or other processing device.

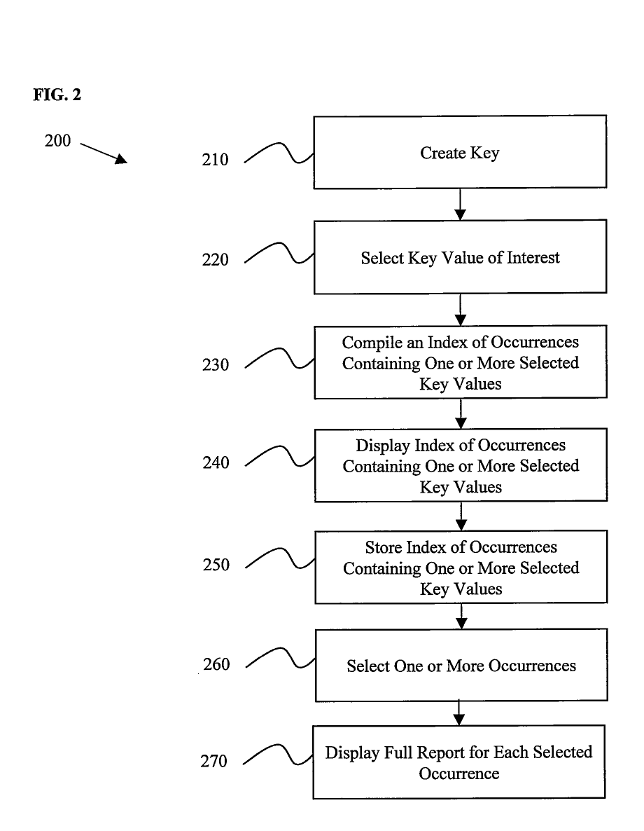

FIG. 2 illustrates a method 200 for the identification and retrieval of relevant archived medical information contained in prior medical examination reports according to an embodiment of the present invention. The method 200 includes the following steps, which are described in more detail below. At step 210, a key is determined. At step 220, a key value is selected. At step 230, data is aggregated. At step 240, the data is displayed. At step 250, the data is stored. At step 260, one or more occurrences containing one or more selected key values are selected. At step 270, full reports for each selected occurrence are displayed. The method 200 is described with reference to the system 100 of FIG. 1, but it should be understood that other implementations are possible.

At step 210, a key is determined. The key may include one or more key values. The one or more key values may be based at least in part on one or more anatomical features of a patient. For example, the one or more key values may include an organ, such as a heart, a lung, a liver, a brain, or a kidney. Alternatively and/or in addition, the one or more key values may include an anatomical feature, such as a head/neck, a spine, a joint, or the skin. As a further example, the one or more key values may include a tissue type, such as a ligament, a tendon, a bone, or a muscle.

At step 220, a key value of interest is selected. In practice, a given archived medical report may be relevant to a physician if that record mentions, for example, the organ, organ system, tissue, or anatomical structure currently being treated or examined. For example, if a key contains all organs, a physician could easily identify relevant prior medical reports by selecting a key value that corresponds to the organ, organ system, tissue, or anatomical structure of interest. Thus, for a patient scheduled to undergo heart surgery, one key value of interest in a key that included a variety of organs would be the term “heart”.

In practice, a radiologist interpreting a follow-up exam for a patient with multiple ailments related to the liver may benefit if all the reports and medical information relating to that patient's liver were identified. Thus, the radiologist would select the term “liver” as a key value to identify all the reports and medical information relating to that patient's liver.

Alternatively, the key value may be selected automatically. For example, each imaging exam follows a preset protocol for image acquisition. Thus, each type of imaging exam could be mapped to organs, tissues or other anatomical structures likely to be imaged as part of the preset protocol before the imaging exam was actually conducted for an individual patient. For example, if a radiologist is preparing to perform a computed tomography chest-abdomen exam, the key values selected may include the following organs that are imaged as part of that preset protocol:

1. liver

2. gallbladder

3. spleen

4. adrenals

5. kidneys

6. pancreas

7. small intestine

8. large intestine

The list of key values may be expanded to include other organs as well.

At step 230, data is aggregated. The data may be aggregated based at least in part on the one or more key values. An index of occurrences containing one or more selected key values is compiled.

In an embodiment, step 230 includes aggregating data based not only on the key value selected, but also on related terms. For example, data including the key value “heart” would be compiled into an index with data including the terms “cardiac” or “myocardial”. This would require using a standardized vocabulary, such as Unified Medical Language System (UMLS), to identify all the synonyms.

In another embodiment, step 230 includes aggregating data based on relevant historical clinical data related to the key value including, for example, pathology tests, lab tests, microbiology tests, radiology reports, and surgical notes. Such relevant historical clinical data may be mapped to associated anatomical structures. For example, lab tests such as those to detect the level of the enzyme creatine kinase in a blood sample give information about muscle damage and, therefore, may be mapped to muscle tissue. Thus, data aggregated in step 230 after the selection of muscle tissue as a key value may include creatine kinase test results.

At step 240, the data is displayed. For example, the data may be displayed using a graphical user interface such as a computer monitor or a display screen on a handheld device. The data may include the data aggregated at step 230.

At step 250, the data is stored. For example, the data may be stored in internal or external memory. The data may include the data aggregated at step 230. The data may include the data displayed at step 240.

In operation, a neurologist interpreting a follow-up exam for a patient who has had multiple ailments related to the brain, for example, could interpret the exam more efficiently if the neurologist could identify all the reports related to the brain easily. At step 220, the key value selected would be “brain”. At step 230, an index of the patient's medical reports containing the term “brain” would be compiled. At step 240, the index would be displayed on, for example, display device 130. At step 250, the index would be stored for future retrieval. At step 260, one or more occurrences in the index could be selected. At step 270, a full report for each selected occurrence would be displayed.

As another example, a referring physician reviewing the latest blood test results for a patient may also want to review historical radiology reports with anatomical significance to the diagnosis.

One or more of the steps 210-270 of the method 200 may be implemented alone or in combination in hardware, firmware, and/or as a set of instructions in software, for example. Certain embodiments may be provided as a set of instructions residing on a computer-readable medium, such as a memory, hard disk, DVD, or CD, for execution on a general purpose computer or other processing device.

Certain embodiments of the present invention may omit one or more of these steps and/or perform the steps in a different order than the order listed. For example, some steps may not be performed in certain embodiments of the present invention. As a further example, certain steps may be performed in a different temporal order, including simultaneously, than listed above.

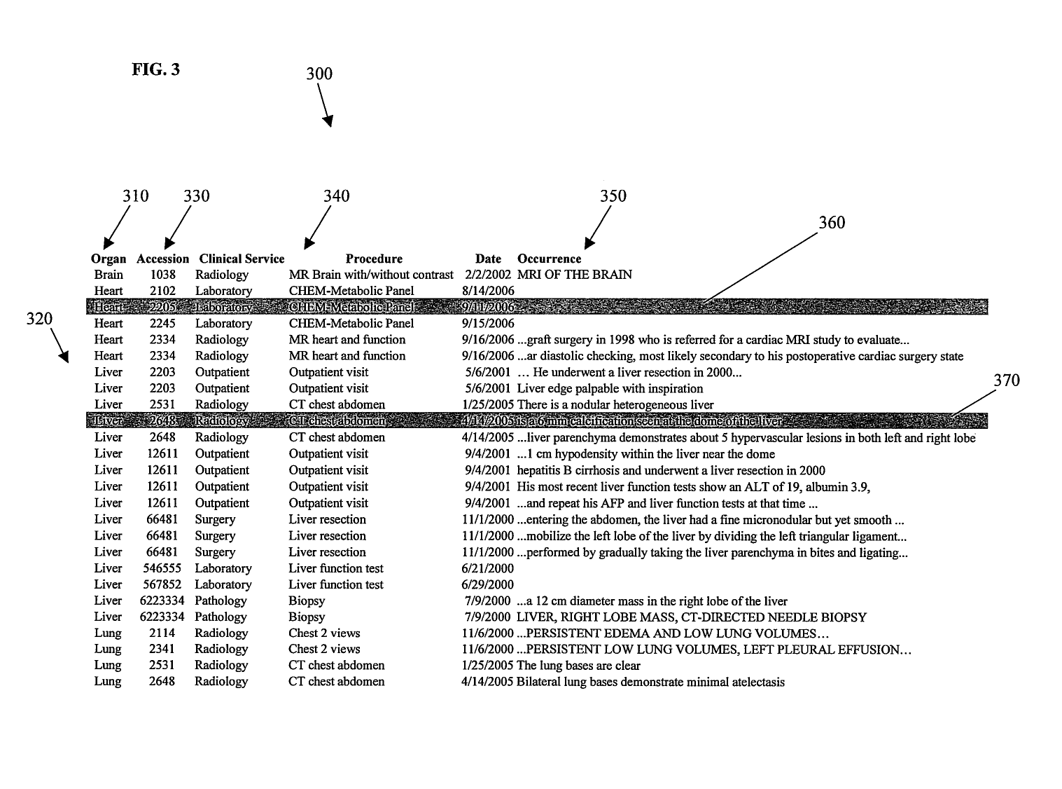

FIG. 3 illustrates an exemplary table 300 of archived medical information for an individual patient. Table 300 may include a list of medical records for one or more patients. For example, table 300 includes line 360 and line 370 which identify individual medical records. Information contained in table 300 may include, for example, the key value 310 and one or more key values 320 contained therein, an identification number 330 for the associated medical record, a description 340 of the clinical service rendered, and the phrase in the record 350 that contains the one or more key values 320.

The key 310 may include a master list of patient features, including organs, tissue types, or other anatomical structures.

The one or more key values 320 may include an organ, an organ system, a type of tissue, or other anatomical features.

The identification number 330 may be, for example, a unique number to identify a particular examination and corresponding examination record.

For example, the identification number 330 may be an accession number.

The description 340 of the service rendered may include, for example, information regarding the department or specialty that provided the service. The description 340 of the service rendered may also include a description of the procedure or examination performed.

The phrase 350 in the record that contains the one or more key values 320 may include, for example, information related to a prior diagnosis or interpretation of a prior medical examination.

Table 300 may include a hyperlink to the complete medical record that contains the one or more key values 320. Selecting a hyperlink from table 300 that corresponds to an individual record would provide the complete text of the associated record.

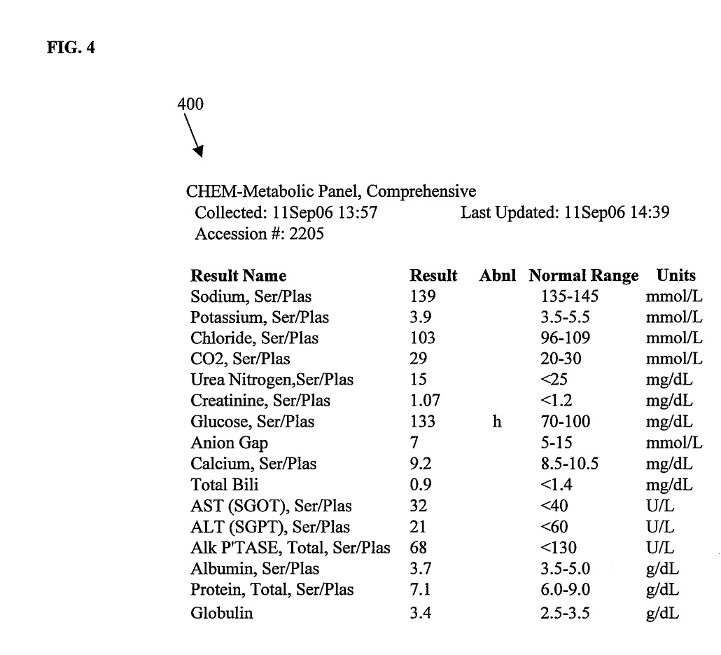

For example, FIG. 4 illustrates a full chemistry metabolic panel 400 that would be provided upon selection of a hyperlink at line 360.

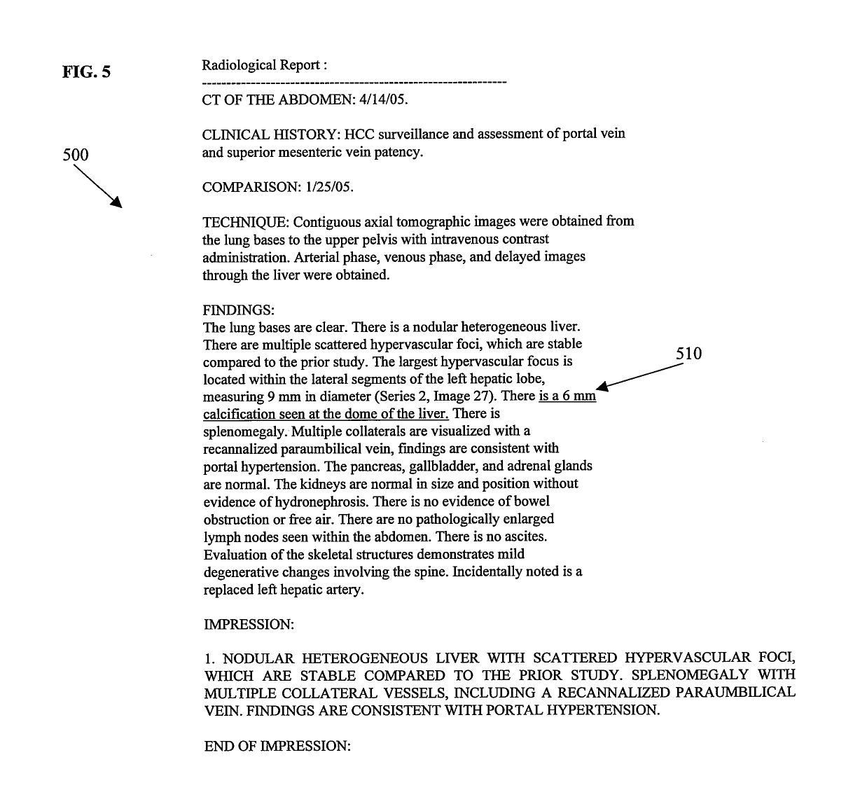

As a further example, FIG. 5 illustrates a full radiology report 500 that would be provided upon selection of a hyperlink at line 360. The full radiology report 500 includes a phrase 510 that contains the key value “liver”.

For a healthcare provider specialist, table 300 would be filtered down to only results that are relevant to his or her specialty. For example, for a liver surgeon reviewing the patient's record, only the results relevant to the liver shown in table 300. The liver surgeon could choose to expand table 300 to view other contents as well.

Certain embodiments of the invention may increase physician productivity by providing more efficient systems and methods to identify and retrieve relevant prior medical information. For example, when diagnosing a patient with multiple historical radiology exams, a physician can more quickly determine which historical report is relevant without having to read all the reports.

Several embodiments are described above with reference to drawings. These drawings illustrate certain details of specific embodiments that implement the systems and methods and programs of the present invention. However, describing the invention with drawings should not be construed as imposing on the invention any limitations associated with features shown in the drawings. The present invention contemplates methods, systems and program products on any machine-readable media for accomplishing its operations. As noted above, the embodiments of the present invention may be implemented using an existing computer processor, or by a special purpose computer processor incorporated for this or another purpose or by a hardwired system.

As noted above, embodiments within the scope of the present invention include program products comprising machine-readable media for carrying or having machine-executable instructions or data structures stored thereon. Such machine-readable media can be any available media that can be accessed by a general purpose or special purpose computer or other machine with a processor. By way of example, such machine-readable media may comprise RAM, ROM, PROM, EPROM, EEPROM, Flash, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such a connection is properly termed a machine-readable medium. Combinations of the above are also included within the scope of machine-readable media. Machine-executable instructions comprise, for example, instructions and data which cause a general purpose computer, special purpose computer, or special purpose processing machines to perform a certain function or group of functions.

Embodiments of the invention are described in the general context of method steps which may be implemented in one embodiment by a program product including machine-executable instructions, such as program code, for example in the form of program modules executed by machines in networked environments. Generally, program modules include routines, programs, objects, components, data structures, etc. that perform particular tasks or implement particular abstract data types. Machine-executable instructions, associated data structures, and program modules represent examples of program code for executing steps of the methods disclosed herein. The particular sequence of such executable instructions or associated data structures represent examples of corresponding acts for implementing the functions described in such steps.

Embodiments of the present invention may be practiced in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet and may use a wide variety of different communication protocols. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. Embodiments of the invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing the overall system or portions of the invention might include a general purpose computing device in the form of a computer, including a processing unit, a system memory, and a system bus that couples various system components including the system memory to the processing unit. The system memory may include read only memory (ROM) and random access memory (RAM). The computer may also include a magnetic hard disk drive for reading from and writing to a magnetic hard disk, a magnetic disk drive for reading from or writing to a removable magnetic disk, and an optical disk drive for reading from or writing to a removable optical disk such as a CD ROM or other optical media. The drives and their associated machine-readable media provide nonvolatile storage of machine-executable instructions, data structures, program modules and other data for the computer.

The foregoing description of embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principals of the invention and its practical application to enable one skilled in the art to utilize the invention in various embodiments and with various modifications as are suited to the particular use contemplated.

Those skilled in the art will appreciate that the embodiments disclosed herein may be applied to the formation of any medical navigation system. Certain features of the embodiments of the claimed subject matter have been illustrated as described herein, however, many modifications, substitutions, changes and equivalents will now occur to those skilled in the art. Additionally, while several functional blocks and relations between them have been described in detail, it is contemplated by those of skill in the art that several of the operations may be performed without the use of the others, or additional functions or relationships between functions may be established and still be in accordance with the claimed subject matter. It is, therefore, to be understood that the appended claims are intended to cover all such modifications and changes as fall within the true spirit of the embodiments of the claimed subject matter.

1. A system for the identification of relevant archived medical information related to one or more patients, the system including:
a user interface component adapted to determine a key;
wherein the key includes one or more key values;
wherein the one or more key values represent one or more anatomical features of said one or more patients; and
a processing component adapted to aggregate data based at least in part on said one or more key values.

2. The system of claim 1, wherein the data is aggregated from one or more medical records.

3. The system of claim 2, wherein the data includes text from said one or more medical records corresponding to said one or more key values.

4. The system of claim 3, further including a display device adapted to display said text.

5. The system of claim 4, wherein said one or more medical records may be displayed in full.

6. The system of claim 1, further including a searchable storage system containing said archived medical information.

7. The system of claim 6, wherein said searchable storage system contains electronic medical records.

8. The system of claim 1, wherein the data includes an examination identification number.

9. The system of claim 1, further including a storage device adapted to store said data.

10. The system of claim 1, wherein said data is aggregated based at least in part on medical terms related to said one or more key values.

11. The system of claim 1, wherein said key is determined automatically.

12. A method for the identification of relevant information related to one or more patients, the method including:
determining a key;
wherein the key includes one or more key values;
wherein the one or more key values represent an anatomical feature of the patient; and
aggregating data based at least in part on said one or more key values.

13. The method of claim 12, wherein the data includes medical data aggregated form one or more medical records.

14. The method of claim 13, wherein the data includes text from said one or more medical records corresponding to said one or more key values.

15. The method of claim 13, wherein the data includes a link to said one or more medical records corresponding to said one or more key values.

16. The method of claim 12, wherein the data includes an examination identification number.

17. The method of claim 12, wherein said key is determined automatically.

18. The method of claim 13, further including displaying said one or more medical reports corresponding to said one or more key values.

19. The method of claim 12, wherein said data is aggregated based at least in part on medical terms related to said one or more key values.

20. A computer-readable storage medium including a set of instructions for a computer, the set of instructions including:
an initialization routine adapted to determine a key;
wherein the key includes one or more key values,
wherein the one or more key values represent one or more anatomical features of one or more patients;
a selection routine adapted to aggregating data based at least in part on said one or more key values; and
a display routine adapted to displaying data that contains said one ore more key values.
